(19) United States
(12) Patent Application Publication
(10) Pub. No.: US 2008/0318467 A1
(43) Pub. Date: Dec. 25, 2008

(54) RELAY RECEPTACLE SHORTING PLUG

(76) Inventors: Gary M. Denomme, Grafton, OH (US); Richard L. Bir, Avon Lake, OH (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/765,247

(22) Filed: Jun. 19, 2007

(51) Int. Cl. H01R 31/08

(52) U.S. Cl. 439/511

(57) ABSTRACT

A relay receptacle shorting plug to short power contacts of a relay receptacle. The shorting plug includes a base having a plurality of terminals projecting from a first end of the base and the terminals have a physical arrangement to mate with contacts of the relay receptacle. The arrangement of the terminals allows for the shorting plug to be matably inserted into the relay receptacle. The terminals include first and second power terminals and at least one control terminal. The shorting plug also includes a closed conductive pathway between the first and second power terminals so that the shorting plug provides a current pathway between first and second power contacts of the relay receptacle. The relay receptacle shorting plug may provide an elongated structure to facilitate insertion and removal of the shorting plug with respect to the relay receptacle.

### TECHNICAL FIELD

The present disclosure relates generally to the field of electronic test equipment. More specifically, the present disclosure relates to a system and method for testing relays and relay circuits in a vehicle with a relay receptacle shorting plug.

### BACKGROUND

Automotive vehicles (e.g., cars and trucks) are increasingly relying on more electronics to support advances in features and performance. To support these advances, the electronic circuitry in automotive vehicles is also becoming increasingly complex. Electro-mechanical relays are a commonly used control device in vehicle electronic circuits. Relays allow a relatively low-power control circuit to turn on a relatively high-power load. A typical relay application involves a switch-activated device that uses a relatively high amount of current. When using a relay, a high current pathway may be present from the power supply to the relay and from the relay to the device.

Automotive devices that are commonly controlled with a relay include, but are not limited to, an air conditioning compressor clutch, a blower or fan, an electronic brake control, a headlight, a horn, an ignition warning, a power window, a defogger, an air-injection pump, a starter, an indicator lamp, a theft deterrent, a turn signal, an instrument cluster, a turn signal, a trunk release, a power locks, a power sunroof, a power tailgate, a fuel fill door, a power antenna, a convertible top, a heated seat, and a turbo-charger boost.

In a typical relay application, a relay may close in response to activation of a switch to supply power to the device. Like fuses, relays are typically replaceable and are packaged in a common area. Also, because of their common use, vehicle manufacturers usually standardize relay configurations so that various applications may use the same relay configuration.

A vehicle's electrical system may use similarly configured relays to control power for many different devices. Thus, many relay designs have been standardized by relay manufacturers and relay users. These standard relays typically have a unique terminal configuration that mates to a matching standard relay receptacle to achieve a one-to-one correspondence between relay type and corresponding receptacle type. A vehicle power distribution box usually includes plural relay receptacles, and possibly fuse receptacles.

The relay receptacles may be difficult to access. For instance, the relay receptacles may be tightly spaced with respect to each other, and/or may be near other vehicle components that block direct access to the relay receptacles by a hand of a technician.

Troubleshooting electrical problems within a vehicle also continues to become more complex. When a device that is controlled by a relay is not functioning properly, there are many potential sources of the problem within the circuitry involved. To diagnose the problem, it is often helpful to narrow the number of potential problem sources. For relay applications, it may be desirable to determine whether the problem is on the control side or the power side of the circuitry involved in controlling and powering the device in question.

In addition to automotive applications, relay-controlled circuits are common in other applications, such as heating ventilation and air conditioning (HVAC), marine, small engine, agricultural, etc.

### SUMMARY

According to one aspect of the disclosure, a relay receptacle shorting plug includes a base having a plurality of terminals projecting from a first end of the base and the terminals having a physical arrangement to mate with contacts of a relay receptacle, wherein the arrangement of the terminals allows for the relay receptacle shorting plug to be matably inserted into the relay receptacle, and the terminals include first and second power terminals and at least one control terminal; a handle extending from a second end of the plug base that provides an elongated structure to facilitate insertion and removal of the relay receptacle shorting plug with respect to the relay receptacle; and a conductor forming part of a closed conductive pathway between the first and second power terminals so that the relay receptacle shorting plug provides a current pathway between the first and second power contacts of the relay receptacle.

According to an embodiment of the relay receptacle shorting plug, the handle includes the conductor.

According to an embodiment of the relay receptacle shorting plug, the closed conductive pathway includes a fuse.

According to an embodiment of the relay receptacle shorting plug, the fuse is removably retained by a fuse holder.

According to an embodiment of the relay receptacle shorting plug, the fuse holder further includes a cover.

According to an embodiment of the relay receptacle shorting plug, the closed conductive pathway includes a first conductor that electrically couples a first terminal of the fuse holder to one of the power terminals and a second conductor that electrically couples a second terminal of the fuse holder to the other of the power terminals.

According to an embodiment, the relay receptacle shorting plug further includes a sleeve disposed around the conductors between the base and the fuse holder.

According to an embodiment, the relay receptacle shorting plug further includes adhesive inside the sleeve to bond the sleeve to at least one of the base, the fuse holder, or the conductors.

According to an embodiment of the relay receptacle shorting plug, the sleeve is made from a shrink tubing material and is shrunk around the conductors.

According to an embodiment of the relay receptacle shorting plug, the sleeve is shrunk around at least one of a hub of the base or a hub of the fuse holder.

According to an embodiment of the relay receptacle shorting plug, the at least one control terminal terminates in an open circuit in the relay receptacle shorting plug.

According to an embodiment of the relay receptacle shorting plug, the relay receptacle is one of an original equipment manufacturer (OEM) or vehicle manufacturer standard relay receptacle.

According to an embodiment, the relay receptacle shorting plug further includes an illumination device that illuminates to indicate a condition of circuitry connected to the relay receptacle.

According to another aspect of the disclosure, a vehicle includes the relay receptacle shorting plug a relay receptacle in which the relay receptacle shorting plug is inserted; a power source that provides electrical energy to the vehicle; a load device, where the vehicle is configured to provide power from the power source to the load device through the relay receptacle; and a switch configured to control the power provided to the load device via the relay receptacle.

According to another aspect of the disclosure, a method for testing an electrical circuit in a vehicle includes removing a relay from a relay receptacle, where the relay receptacle is configured such that power is supplied to a load device through power contacts of the relay receptacle; inserting the relay receptacle shorting plug into the relay receptacle; and observing the flow or lack of flow of current through the load.

According to another aspect of the disclosure, a relay receptacle shorting plug includes a base having a plurality of terminals projecting from a first end of the base and the terminals having a physical arrangement to mate with contacts of a relay receptacle, wherein the arrangement of the terminals allows for the relay receptacle shorting plug to be matably inserted into the relay receptacle, and the terminals include first and second power terminals and at least one control terminal; and a fuse holder in an electrical pathway between the first and second power terminals and a fuse retained by the fuse holder to complete a closed conductive pathway between the first and second power terminals so that the relay receptacle shorting plug provides a fused current pathway between first and second power contacts of the relay receptacle.

According to an embodiment of the relay receptacle shorting plug, the relay receptacle is one of an original equipment manufacturer (OEM) or vehicle manufacturer standard relay receptacle.

According to an embodiment of the relay receptacle shorting plug, the fuse holder is in spaced relationship to the base.

According to another aspect of the disclosure, relay receptacle shorting plug includes a base having a cross-sectional shape and size to represent a relay of a vehicle; a plurality of terminals projecting from a first end of the base, the terminals having a physical arrangement to mate with contacts of a relay receptacle of the vehicle for matable insertion of the relay receptacle shorting plug into the relay receptacle, and the terminals include first and second power terminals and a terminal that represents a relay control terminal; and a conductive pathway between the first and the second power terminals.

According to an embodiment of the relay receptacle shorting plug, the conductive pathway includes a fuse.

These and other aspects, advantages and features will be apparent from the following description taken with reference to the accompanying drawings. Features that are described and/or illustrated with respect to one embodiment may be used in the same way or in a similar way in one or more other embodiments and/or in combination with or instead of the features of the other embodiments.

### BRIEF DESCRIPTION OF DRAWINGS

FIG. 1 is a schematic view of a vehicle that includes a relay and an associated electrical circuit for a device controlled by the relay;

FIG. 2 is a schematic view of the vehicle of FIG. 1 where a relay receptacle shorting plug is used in place of the relay;

FIG. 3 is a side view of an exemplary relay receptacle shorting plug;

FIG. 4 is a schematic illustration of the relay receptacle shorting plug of FIG. 3;

FIG. 5 is an end view of the exemplary relay receptacle shorting plug of FIG. 3; and

FIG. 6 is an end view of another exemplary relay receptacle shorting plug.

### DETAILED DESCRIPTION

In the detailed description that follows, corresponding components have been given the same reference numerals, regardless of whether they are shown in different embodiments. To illustrate various features in a clear and concise manner, the drawings may not necessarily be to scale and certain features may be shown in somewhat schematic form.

In the present application, features are described primarily in the context of an automotive vehicle. However, it will be appreciated that the invention, as defined by the appended claims, is not intended to be limited to this context and may be used in many other applications, such as trains, airplanes, helicopters, boats, machinery, and any other domestic or industrial application.

Due to the complexity and quantity of electronic circuits in automotive vehicles, troubleshooting electrical faults may be a difficult and time consuming procedure. Usually, an initial step of the troubleshooting process is an attempt to isolate the fault. Narrowing down the location of an electrical fault may reduce the amount of time it may take to identify and fix the problem. In relay circuits, a diagnostic tool that may help isolate whether the fault is located in control circuitry or in power circuitry would be useful.

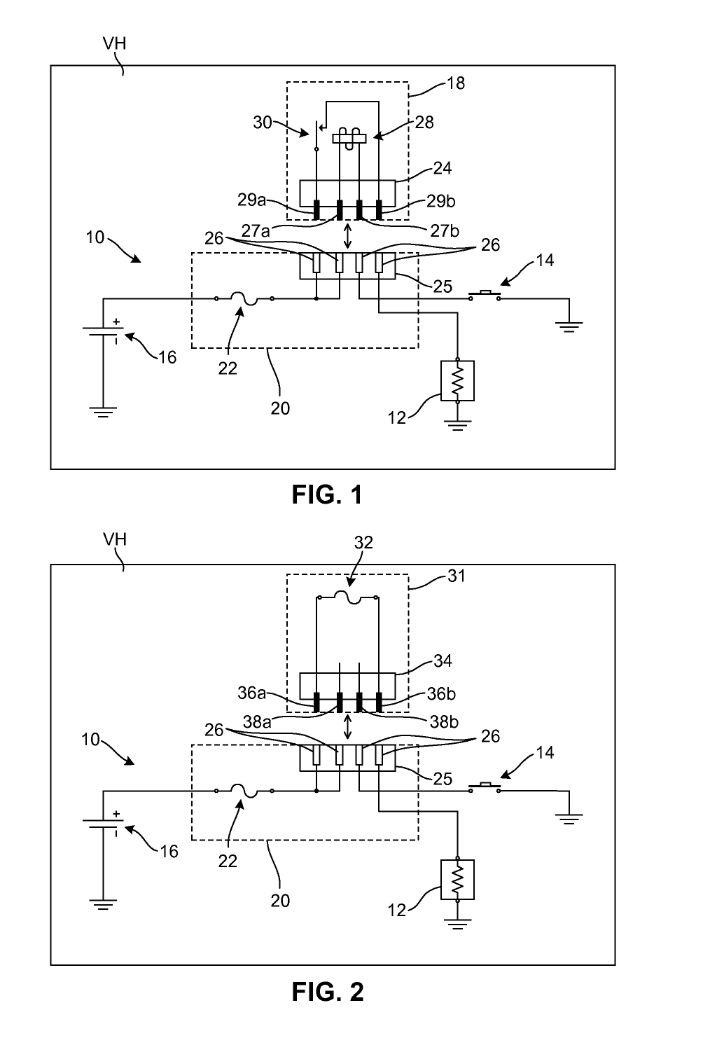

Referring initially to FIG. 1, a vehicle VH having an electrical circuit 10 is shown. The circuit 10 supplies power to an automotive device 12 (also referred to as a load). A switch 14 controls whether the device 12 should be on or off. In the illustrated configuration, the switch 14 is normally open and the device 12 is normally off, but the reverse is possible. Also, the switch 14 may be a momentary switch. When the user closes the switch 14, the circuit 10 is configured to turn the device 12 on. The vehicle power supply is shown as a battery 16. The circuit 10 uses a relay 18 to control the supply of power to the device 12. The relay 18 is shown coupled to a power distribution box 20. A fuse 22 is also shown in the power distribution box 20 to protect the circuit 10 and device 12 from drawing too much current.

The relay 18 includes a relay base 24 for coupling the relay 18 to the power distribution box 20. The power distribution box 20 includes a relay receptacle 25 for receiving the relay 18. The relay base 24 includes plural terminals projecting out from a front end of the relay base 24. The relay receptacle 25 includes corresponding contacts 26 that mate with the relay base 24 terminals when the relay 18 is coupled to the relay receptacle 25 in the power distribution box 20.

When inserted into the receptacle 25, the relay 18 becomes part of the circuit 10 such that the switch 14 may control the supply of power to the device 12. The relay 18 completes both a control circuit portion and a power circuit portion of the circuit 10. The control circuit portion of the circuit 10 is configured to send a signal from the switch 14 to the relay 18 that the device 12 should turn on. The control circuit portion of the circuit 10 is configured to conduct relatively low current through control terminals 27 of the relay base 24, a relay coil 28 in the relay 18, and the switch 14. The power circuit portion of the circuit 10 is configured to supply power to the device 12. The power circuit portion is designed to conduct relatively high current through power terminals 29 of the relay base 24, an internal relay switch 30 in the relay 18, and the device 12.

In operation, when the switch 14 is closed, the circuit 10 supplies power to the relay coil 28. When powered, the relay coil 28 closes the internal relay switch 30. The position of the relay switch 30 may be held closed in accordance with the position of the switch 14 or may be latched closed in the case of a momentary switch 14. In addition to the switch 14 or instead of the switch 14, other control devices (e.g., dedicated circuit components and/or a processor-based component that executes a logical routine) may be involved in controlling operation of the relay 18. When the internal relay switch 30 is closed, the circuit 10 supplies power to the device 12. Conversely, when the switch 14 is open, the circuit 10 does not supply power to the relay coil 28, the internal relay switch 30 is open, and no current is supplied to the device 12.

Referring now to FIG. 2, the vehicle circuit 10 is shown without the relay 18 in the relay receptacle 25. Instead, the relay 18 has been replaced with a relay receptacle shorting plug 31 that is coupled to the relay receptacle 25. The relay receptacle shorting plug 31 establishes a short between a pair of power terminals. A fuse 32 is also shown as part of the relay receptacle shorting plug 31 to protect the relay receptacle shorting plug 31.

Like the relay base 24 of the relay 18, the relay receptacle shorting plug 31 also has a plug base 34 that has power terminals 36 and control terminals 38. Together, the power terminals 36 and the control terminals 38 are configured to be compatible with and mate to the relay receptacle 25. The plug base 34 may be configured (e.g., in terms of cross-sectional shape and size) to be compatible with the relay receptacle 25 such that the relay receptacle shorting plug 31 may be coupled to the relay receptacle 25 in the same manner as the relay 18, after the relay 18 is removed. In this regard, the plug base 34 may be considered an overmolded base that is physically configured to represent the relay 18.

While the relay 18 of FIG. 1 and the relay receptacle shorting plug 31 of FIG. 2 are shown as being spaced apart from the receptacle 25, it will be understood that these components may be inserted into the receptacle as indicated by the arrows in FIGS. 1 and 2, respectively.

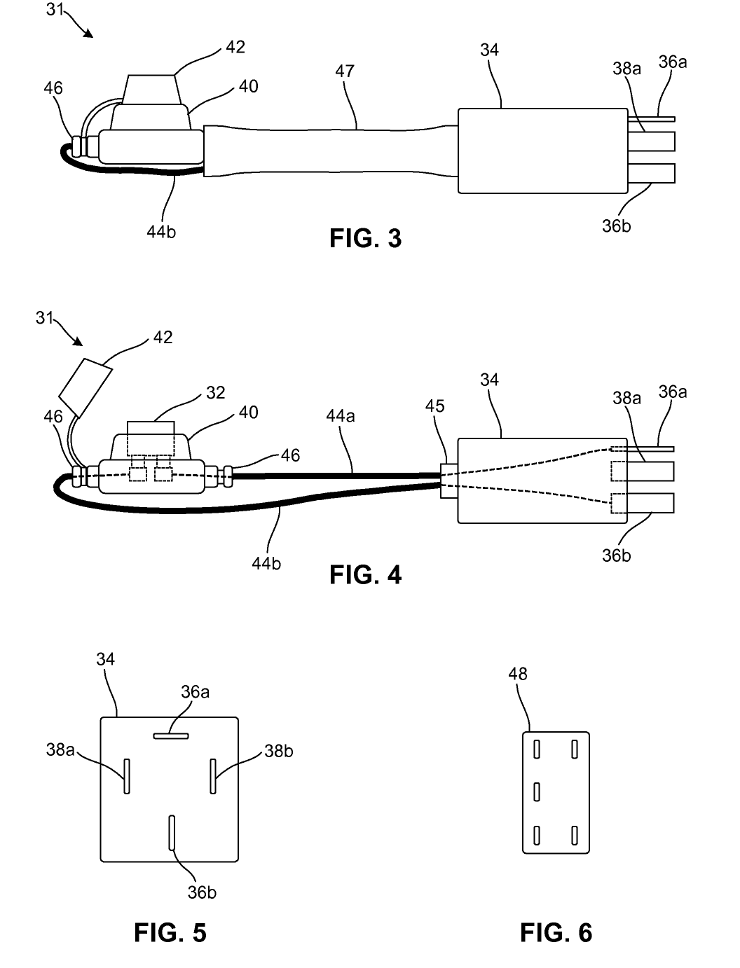

With additional reference to FIGS. 3 through 5, the plug base 34 may be a molded (e.g., injection molded) housing that retains the power terminals 36 and the control terminals 38. FIG. 5 best shows an exemplary layout of the terminals 36, terminals 38, and a shape of the base 34.

The relay receptacle shorting plug 31 also may have a fuse holder 40 and a fuse cover 42. As shown in FIG. 4, the fuse holder 40 may retain the fuse 32. The fuse cover 42 may be tethered to the fuse holder 40, but may be removed from the body of the fuse holder 40 for access to the fuse 32.

As shown in FIGS. 3 and 4, a first conductor 44a may be coupled to a first fuse terminal within the fuse holder 40 and a first power terminal 36a. A second conductor 44b may be coupled to a second fuse terminal within the fuse holder 40 and a second power terminal 36b. These conductors 44 and the fuse 32 complete the power portion of the circuit 10 through the relay receptacle shorting plug 31 by shorting power terminals 36a and 36b. The conductors 44 may be insulated wires. The conductors 44 may exit and extend from the base 34 through an aperture in an end of the base 34 opposite an end from which the terminals 36 and 38 extend.

A hub 45 may be integrally formed with the base 34 and surround the conductors 44 as the conductors 44 exit the base 34. The conductor 44a may enter the fuse holder 40 through an aperture located at a first end of the fuse holder 40. Similarly, the conductor 44b may enter the fuse holder 40 through an aperture located at a second end of the fuse holder 40. The fuse holder 40 may include hubs 46 through which the conductors 44 respectively extend. The conductors 44 need not be continuous pieces of wire. For example, wires that are molded into the base 34 and wires that are molded into the fuse holder 40 may be electrically and/or mechanically joined, such as by soldering, welding, crimping, twisting, etc. Insulating material (e.g., heat shrinkable material, electrical tape, crimpable connectors, etc.) may be used to cover a connection to minimize formation of an unintended short.

As shown in FIG. 3, a sleeve 47 may be disposed around the conductors 44, a proximal hub 46 of the fuse holder 40, and the hub 45 of the plug base 34. FIG. 4 shows the sleeve 47 removed from the relay receptacle shorting plug 31. The sleeve 47 may be made from heat-shrinkable material that has been heat-shrunk around the conductors 44 and hubs. In addition, or in the alternative, the sleeve 47 may be secured to the conductors 44 and hubs with adhesive or other mechanical fastening technique. In another embodiment, the sleeve 47 may be integrally formed with the base 34, the fuse holder 40, or both. In another embodiment, the sleeve 47 may be made from a tape, a wrap, or a web that is wound around the conductors 44 and, if appropriate, the hubs. The sleeve 47 may protect the conductors 44.

The sleeve 47 may be less flexible than the conductors 44 so as to lead to the creation of a sufficiently rigid assembly that makes insertion and removal of the relay receptacle shorting plug 31 easier. The assembly may be completely rigid (e.g., unbendable) or may have some flexibility, especially in the region between the plug base 34 and the fuse holder 40. As mentioned above, it is common for a relay 18 to be packaged in a power distribution box 20 amongst many other relays, and may be positioned in a hard to access location. Thus, the relay receptacle shorting plug 31 of the illustrated embodiment provides an elongated structure to facilitate insertion and removal of the plug base 34 in and out of the relay receptacle 25. For instance, a user may grasp the fuse holder 40, the sleeve 47 and/or the conductors 44 to insert or remove the relay receptacle shorting plug 31 into or out of the receptacle 25 while maintaining a spaced relationship between the user's hand and the receptacle 25. In this example, one or more of the fuse holder 40, the sleeve 47 or the conductors 44 serve as a handle to facilitate insertion and removal of the relay receptacle shorting plug 31. A different type of member may be attached to or integrally formed with the plug base 34 to serve as a handle. For instance, the handle may be an extended portion of the plug base 34.

When coupled to the relay receptacle 25 in the power distribution box 20, the relay receptacle shorting plug 31 provides a current pathway for the power portion of the circuit 10, thereby replicating a closed relay. In this configuration, the switch 14 no longer controls the supply of power to the device 12. The conductive pathway of the relay receptacle shorting plug 31 completes the power portion of the circuit 10, simulating that the switch 14 has been set to turn on the device 12, the relay 18 is operating properly and the control portions of the circuit 10 are operating properly.

The relay receptacle shorting plug 31 may not complete a control circuit pathway through the control terminals 38 of the plug base 34. The control terminals 38 may be present for proper alignment of the relay receptacle shorting plug 31 with respect to the receptacle 25, but may not be physically or electrically connected to anything. In one embodiment, the control terminals 38 may be connected to insulated wires (not shown) that extend through the aperture of the base 34 with the conductors 44. The wires, if present, may terminate in the sleeve 47. Additional insulating material (e.g., heat-shrinkable tubing, electrical tape, caps, etc.) may be added to minimize the formation of a short between the wires or between a wire and one of the conductors 44.

The relay receptacle shorting plug 31 may be used to troubleshoot the circuit 10 if the device 12 is not operating properly in the presence of the relay 18. When the relay receptacle shorting plug 31 is coupled to the receptacle 25 instead of the relay 18, the relay receptacle shorting plug 31 may help the operator determine if the fault exists in the control portion of the circuit 10, if the fault exists in the power portion of the circuit 10, or if the relay 18 is faulty.

For example, if the device 12 is not energizing when the switch 14 is placed in an on position, the operator may remove the relay 18 from the relay receptacle 25 in the power distribution box 20. Then, the relay receptacle shorting plug 31 may be inserted into the relay receptacle 25. As a result, the circuit configuration that would normally activate the device 12 may be replicated by simulating that the switch 14 is placed in an on position (e.g., the switch is toggled to a closed position or the switch is momentarily closed to trigger the relay 18) and the control portion of the circuit 10 is operating properly. If the device 12 does not activate, there may be a fault in the power portion of the circuit 10 (e.g., wiring problem, blown fuse 22, battery 16 fault, or an inoperable device 12). If the device 12 does activate, there may be a fault with the relay 18 or the control portions of the circuit 10 (e.g., wiring problem or switch 14 fault). The relay receptacle shorting plug 31 may be designed to remain in the relay receptacle 25, without operator intervention, while diagnostic procedures are performed. Therefore, it will be appreciated that the relay receptacle shorting plug 31 and a method of using the relay receptacle shorting plug 31 may facilitate the identification and/or isolation of a potential fault area while troubleshooting a problem involving a relay controlled device in a vehicle.

The plug base 34 configuration may be configured to be compatible with the relay receptacle 25 of any relay 18. These include, but are limited to, power and accessory style relays. FIG. 6 represents an example of another base 48 style that would be compatible with another type of relay receptacle 25. In the illustrated examples, the arrangement of the terminals 36, 38 have a one-to-one correspondence with the arrangement of the contacts 26. Therefore the relay receptacle shorting plug 31 may be inserted in a proper orientation to complete a conductive pathway between the appropriate power contacts 26 of the relay receptacle 25. In other embodiments, proper orientation may be achieved by establishing a mechanical interference between the relay receptacle shorting plug 31 and the receptacle 25, if proper orientation is not present. In this manner, a technician may not need to know or guess which contacts 26 of the receptacle should be shorted to couple power to the device 12.

In another embodiment, each of the control terminals 38 are coupled to a conductor (not shown) that terminates in an open circuit in the relay receptacle shorting plug 31.

In another embodiment, the relay receptacle 25 may be an original equipment manufacturer (OEM) or a vehicle manufacturer standard relay receptacle.

In another embodiment, the relay receptacle shorting plug 31 does not include a spaced relationship between the fuse holder 40 and the plug base 34. In this embodiment, the fuse holder 40 may be coupled directly to or integral with the plug base 34.

In another embodiment, a vehicle includes the relay receptacle shorting plug 31 as a troubleshooting apparatus.

In another embodiment, the operator may follow a method of testing a vehicle using the relay receptacle shorting plug 31 by removing the relay 18 from the relay receptacle 25, inserting the relay receptacle shorting plug 31 into the relay receptacle 25, and observing the flow or lack of flow of current through the power portion of the circuit 10. Observing current flow may be made by use of a meter, or by watching, listening to, smelling, or feeling the device 12. In one embodiment, manufacturing quality control may be carried out by using the relay receptacle shorting plug 31 prior to insertion of the relay 18 for the first time.

The relay receptacle shorting plug 31 may also be configured to include a push-button or other style switch that may open and close the power portion of the circuit 10. This may allow the operator to turn off the power to the device 12 without removing the relay receptacle shorting plug 31 from the receptacle 25.

Also, the relay receptacle shorting plug 31 may include a light or light emitting diode (LED) that may illuminate when power is available from the power portion of the circuit 10. In addition, or in the alternative, the relay receptacle shorting plug 31 may include a light or LED that may illuminate when power is drawn through the relay receptacle shorting plug 31 by the device 12. If an illumination device(s) is present, a connection to ground, a current detector and/or a voltage detector also may be present.

Although particular embodiments have been described and illustrated in detail, it is understood that the invention as defined by the appended claims is not limited correspondingly in scope, but includes all changes, modifications and equivalents.

What is claimed is:

1. A relay receptacle shorting plug, comprising:
a base having a plurality of terminals projecting from a first end of the base and the terminals having a physical arrangement to mate with contacts of a relay receptacle, wherein the arrangement of the terminals allows for the relay receptacle shorting plug to be matably inserted into the relay receptacle, and the terminals include first and second power terminals and at least one control terminal;
a handle extending from a second end of the plug base that provides an elongated structure to facilitate insertion and removal of the relay receptacle shorting plug with respect to the relay receptacle; and
a conductor forming part of a closed conductive pathway between the first and second power terminals so that the relay receptacle shorting plug provides a current pathway between the first and second power contacts of the relay receptacle.

2. The relay receptacle shorting plug according to claim 1, wherein the handle includes the conductor.

3. The relay receptacle shorting plug according to claim 2, wherein the closed conductive pathway includes a fuse.

4. The relay receptacle shorting plug according to claim 3, wherein the fuse is removably retained by a fuse holder.

5. The relay receptacle shorting plug according to claim 4, wherein the fuse holder further includes a cover.

6. The relay receptacle shorting plug according to claim 4, wherein the closed conductive pathway includes a first conductor that electrically couples a first terminal of the fuse holder to one of the power terminals and a second conductor that electrically couples a second terminal of the fuse holder to the other of the power terminals.

7. The relay receptacle shorting plug according to claim 6, further comprising a sleeve disposed around the conductors between the base and the fuse holder.

8. The relay receptacle shorting plug according to claim 7, further comprising adhesive inside the sleeve to bond the sleeve to at least one of the base, the fuse holder, or the conductors.

9. The relay receptacle shorting plug according to claim 7, wherein the sleeve is made from a shrink tubing material and is shrunk around the conductors.

10. The relay receptacle shorting plug according to claim 9, wherein the sleeve is shrunk around at least one of a hub of the base or a hub of the fuse holder.

11. The relay receptacle shorting plug according to claim 1, wherein the at least one control terminal terminates in an open circuit in the relay receptacle shorting plug.

12. The relay receptacle shorting plug according to claim 1, wherein the relay receptacle is one of an original equipment manufacturer (OEM) or vehicle manufacturer standard relay receptacle.

13. The relay receptacle shorting plug according to claim 1, further comprising an illumination device that illuminates to indicate a condition of circuitry connected to the relay receptacle.

14. A vehicle, comprising:
the relay receptacle shorting plug according to claim 1;
a relay receptacle in which the relay receptacle shorting plug is inserted;
a power source that provides electrical energy to the vehicle;
a load device, where the vehicle is configured to provide power from the power source to the load device through the relay receptacle; and
a switch configured to control the power provided to the load device via the relay receptacle.

15. A method for testing an electrical circuit in a vehicle, comprising the steps of:
removing a relay from a relay receptacle, where the relay receptacle is configured such that power is supplied to a load device through power contacts of the relay receptacle;
inserting the relay receptacle shorting plug according to claim 1 into the relay receptacle; and
observing the flow or lack of flow of current through the load.

16. A relay receptacle shorting plug, comprising:
a base having a plurality of terminals projecting from a first end of the base and the terminals having a physical arrangement to mate with contacts of a relay receptacle, wherein the arrangement of the terminals allows for the relay receptacle shorting plug to be matably inserted into the relay receptacle, and the terminals include first and second power terminals and at least one control terminal; and
a fuse holder in an electrical pathway between the first and second power terminals and a fuse retained by the fuse holder to complete a closed conductive pathway between the first and second power terminals so that the relay receptacle shorting plug provides a fused current pathway between first and second power contacts of the relay receptacle.

17. The relay receptacle shorting plug according to claim 16, wherein the relay receptacle is one of an original equipment manufacturer (OEM) or vehicle manufacturer standard relay receptacle.

18. The relay receptacle shorting plug according to claim 16, wherein the fuse holder is in spaced relationship to the base.

19. A relay receptacle shorting plug, comprising:
a base having a cross-sectional shape and size to represent a relay of a vehicle;
a plurality of terminals projecting from a first end of the base, the terminals having a physical arrangement to mate with contacts of a relay receptacle of the vehicle for matable insertion of the relay receptacle shorting plug into the relay receptacle, and the terminals include first and second power terminals and a terminal that represents a relay control terminal; and
a conductive pathway between the first and the second power terminals.

20. The relay receptacle shorting plug of claim 19, wherein the conductive pathway includes a fuse.
